(19) United States
(12) Patent Application Publication
(10) Pub. No.: US 2025/0146466 A1
(43) Pub. Date: May 8, 2025

(54) DISTRIBUTED ARCHITECTURE IGNITION SYSTEM

(71) Applicant: Altronic LLC, Girard, OH (US)

(72) Inventors: David LEPLEY, Cortland, OH (US); Matthew TRAINA, Ravenna, OH (US); Gary KLEINFELDER, Girard, OH (US)

(21) Appl. No.: 18/938,426

(22) Filed: Nov. 6, 2024

Related U.S. Application Data
(60) Provisional application No. 63/597,019, filed on Nov. 8, 2023.

(51) Int. Cl. F02P 5/15

(52) U.S. Cl. CPC F02P 5/1502

(57) ABSTRACT

A system and method for controlling an ignition system. An ignition coil assembly has an ignition transformer with primary and secondary windings and a local control unit. A spark apparatus is connected with the secondary winding of the ignition transformer. The local control unit is adapted to regulate ignition timing of the ignition transformer for generating a spark at the spark apparatus to ignite a fuel-air mixture in an engine cylinder. A central control unit is in electronic communication with the local control unit for monitoring the ignition transformer.

### FIELD

The present teachings relate generally to power electronics and, more particularly, to ignition systems that may be used with combustion engines.

### BACKGROUND

In general, an ignition system generates a high voltage that is sent to a spark plug to create a spark, as is appreciated by one skilled in the art. The spark in turn ignites a fuel-air mixture in an engine's combustion chamber(s) to drive the engine. The ignition coil (also referred to as ignition transformer) typically produces the high voltage. U.S. Pat. No. 7,401,603, entitled “High tension capacitive discharge ignition with reinforcing triggering pulses”, discloses an ignition system and is incorporated by reference in its entirety.

Known ignition systems utilize centralized control, meaning that they have a single control unit that may be used with multiple ignition transformers, as is appreciated by one skilled in the art. However, benefits may be realized by using a distributed control system, as discussed below.

Therefore, it would be beneficial to have an alternative system and method for a distributed architecture ignition system.

### SUMMARY

The needs set forth herein as well as further and other needs and advantages are addressed by the present embodiments, which illustrate solutions and advantages described below.

One embodiment of a system according to the present teachings includes, but is not limited to, an ignition system with a central control unit. An ignition coil assembly (or multiple assemblies) has an ignition transformer with primary and secondary windings and a local control unit. The local control unit is adapted to regulate ignition timing of the ignition transformer for generating a spark at a spark apparatus (e.g., connected in series with the secondary winding of the ignition transformer) to ignite a fuel-air mixture in an engine cylinder. The central control unit is in electronic communication with the local control unit for monitoring the ignition transformer.

In one embodiment, the local control unit steps up a final primary drive within the coil assembly, such that a higher primary drive voltage is provided while using low-voltage cabling with the central control unit.

In one embodiment, the central control unit provides 50V or less to the ignition coil assembly, which steps up the final primary drive to 400V or more.

In one embodiment, the ignition coil assembly includes a power supply to step up the final primary drive in the coil assembly.

In one embodiment, the central control unit is in electronic communication with the local control unit over a twisted pair cable.

In one embodiment, the twisted pair cable comprises Ethernet cable.

In one embodiment, the local control unit increases voltage of a primary drive input within the coil assembly.

In one embodiment, the spark apparatus comprises a spark plug.

In one embodiment, the system has one or more additional ignition coil assemblies. Each of the one or more additional ignition coil assemblies has a control unit adapted to regulate ignition timing of an associated ignition transformer.

In one embodiment, the ignition coil assembly includes at least one sensor, such that the local control unit regulates ignition timing based on a measurement sensed by the sensor. The central control unit is in electronic communication with the local control unit over a twisted pair cable.

One embodiment of a method according to the present teachings includes, but is not limited to, a method for controlling an ignition system. A central control unit is provided. An ignition coil assembly is provided having an ignition transformer with primary and secondary windings and a local control unit. Ignition timing of the ignition transformer is regulated with the local control unit to generate a spark at a spark apparatus (e.g., connected with the secondary winding of the ignition transformer) to ignite a fuel-air mixture in an engine cylinder.

In one embodiment, the local control unit is monitored with the central control unit.

One embodiment of an ignition coil assembly according to the present teachings includes, but is not limited to, an ignition transformer with primary and secondary windings and a control unit adapted to regulate ignition timing of the ignition transformer for generating a spark at a spark apparatus for igniting a fuel-air mixture in an engine cylinder. The control unit is adapted to be in electronic communication with a central control unit that monitors the ignition transformer.

In one embodiment, the ignition coil assembly includes a power supply to step up the final primary drive in the coil assembly, such that a higher primary drive voltage is provided while using low-voltage cabling with the central control unit.

In one embodiment, the ignition coil assembly includes at least one measured value, such that the local control unit regulates ignition timing based on the at least one measured value.

In one embodiment, the ignition coil assembly includes at least one sensor for sensing the at least one measured value.

In one embodiment, the at least one measured value comprises position data of an engine crank shaft.

One embodiment of an engine ignition system according to the present teachings includes, but is not limited to, an engine having a plurality of cylinders, each of the plurality of cylinders having an associated assembly according to the present teachings. A central control unit is in electronic communication with each associated assembly over a twisted pair cable.

In one embodiment, the central control unit receives a diagnostic measurement of a first of the associated assemblies and modifies operation of at least a second of the associated assemblies based at least in part on the diagnostic measurement.

In one embodiment, the ignition coil assembly includes at least one measured value (e.g., may include a sensor or receive from another source such as a sensor on a cylinder, etc.), such that the control unit regulates ignition timing based on the measured value. The central control unit is in electronic communication with the ignition coil assembly control unit over a twisted pair cable.

Other embodiments of the system and method are described in detail below and are also part of the present teachings.

For a better understanding of the present embodiments, together with other and further aspects thereof, reference is made to the accompanying drawings and detailed description, and its scope will be pointed out in the appended claims.

### BRIEF DESCRIPTION OF THE DRAWINGS

FIG. 1 is an illustration of one embodiment of a system according to the present teachings.

FIG. 2 is an illustration of another embodiment of a system according to the present teachings.

FIG. 3 is an illustration of the embodiments of FIGS. 1 and 2 incorporated into engine ignition control.

### DETAILED DESCRIPTION

The present teachings are described more fully hereinafter with reference to the accompanying drawings, in which the present embodiments are shown. The following description is presented for illustrative purposes only and the present teachings should not be limited to these embodiments. Any computer configuration and architecture satisfying the speed and interface requirements herein described may be suitable for implementing the system and method of the present embodiments.

In compliance with the statute, the present teachings have been described in language more or less specific as to structural and methodical features. It is to be understood, however, that the present teachings are not limited to the specific features shown and described, since the systems and methods herein disclosed comprise preferred forms of putting the present teachings into effect.

For purposes of explanation and not limitation, specific details are set forth such as particular architectures, interfaces, techniques, etc. in order to provide a thorough understanding. In other instances, detailed descriptions of well-known devices, circuits, and methods are omitted so as not to obscure the description with unnecessary detail.

A “computing system” may provide functionality for the present teachings. The computing system may include software executing on computer readable media that may be logically (but not necessarily physically) identified for particular functionality (e.g., functional modules). The computing system may include any number of computers/processors, which may communicate with each other over a network. The computing system may be in electronic communication with a datastore (e.g., database) that stores control and data information. Forms of computer readable media include, but are not limited to, disks, hard drives, random access memory, programmable read only memory, or any other medium from which a computer can read.

Generally, all terms used in the claims are to be interpreted according to their ordinary meaning in the technical field, unless explicitly defined otherwise herein. All references to a/an/the element, apparatus, component, means, step, etc. are to be interpreted openly as referring to at least one instance of the element, apparatus, component, step, etc., unless explicitly stated otherwise. The steps of any method disclosed herein do not have to be performed in the exact order disclosed, unless explicitly stated. The use of “first”, “second,” etc. for different features/components of the present disclosure are only intended to distinguish the features/components from other similar features/components and not to impart any order or hierarchy to the features/components.

To aid the Patent Office and any readers of a patent issued on this application in interpreting the claims appended hereto, it is noted that none of the appended claims or claim elements are intended to invoke 35 U.S.C. 112(f) unless the words “means for” or “step for” are explicitly used in the particular claim.

Recitations of numerical ranges by endpoints include all numbers within that range (e.g., 1 to 5 includes 1, 1.5, 2, 2.75, 3, 3.80, 4, 5, etc.). Where a range of values is “greater than”, “less than”, etc., of a particular value, that value is included within the range.

Any direction referred to herein, such as “top,” “bottom,” “left,” “right,” “upper,” “lower,” “above,” “below,” and other directions and orientations are described herein for clarity in reference to the figures and are not to be limiting of an actual device or system or use of the device or system. Many of the devices, articles, or systems described herein may be used in a number of directions and orientations.

Any citation to a reference in this disclosure or during the prosecution thereof is made out of an abundance of caution. No citation (whether in an Information Disclosure Statement or otherwise) should be construed as an admission that the cited reference qualifies as prior art or comes from an area that is analogous or directly applicable to the present teachings.

The present teachings include a distributed architecture ignition system. This may be based on enhanced capacitive-discharge technology, where the ignition coil assembly is up-integrated with control and power electronics, although not limited thereto. Such a configuration provides many benefits, including improved packaging, signal processing, control, and miniaturization, although not limited thereto.

In one embodiment, each of one or more ignition coil assemblies (e.g., ignition transformer and electronics) has its own control unit. A central control unit (e.g., ECU) may be in electronic communication with these “smart” ignition coils. Connections may be provided with a communication cable such as a 4-pair CAT5e/6 cable (e.g., Ethernet cable), although not limited thereto. In this way, an ignition coil's primary drive may be made “local” to the coil but can be monitored by the central control unit.

Having a local control unit (also referred to as distributed control unit, etc.) provides a number of new and improved features over prior systems. These include distributed architecture, local primary drive, local signal processing, local decision making, etc. It also provides the ability to integrate additional electronics with the ignition coil. For example, sensors may be added such as temperature sensors and acceleration sensors, although not limited thereto.

One skilled in the art appreciates that a variety of sensors may be employed local to the coil to measure things like temperature (e.g., internal to coil) and acceleration (e.g., again, internal to coil). Sensors may also be employed to serve as “signal processing and digitalization” points. This may allow, for example, a user to connect cylinder-based sensors (e.g., in-cylinder pressure diagnostics, etc.) to coil electronics instead of running a wire connection to a central control unit, although not limited thereto.

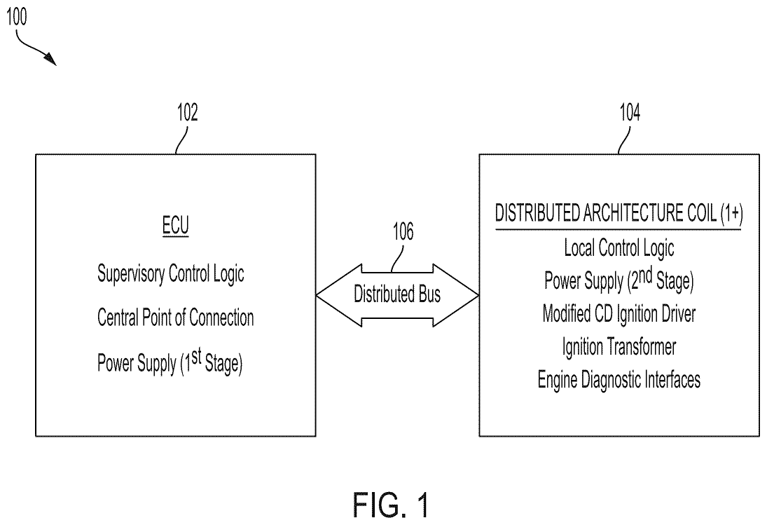

Referring now to FIG. 1, shown is an illustration of one embodiment of a system 100 according to the present teachings. A central control unit 102 (e.g., electronic control unit or ECU) may provide a central point of connection for the ignition system 100. While central control units are known in the art, a central control unit 102 according to the present teachings may provide supervisory control logic (e.g., monitoring, high-level control, provide data and ignition strategy, etc.) for the distributed control units, as is appreciated by one skilled in the art. The central control unit 102 may also provide some or all of the power supply (e.g., 1^{st} stage), although not limited thereto.

Each ignition coil assembly 104 may have its own control logic, including a (distributed/local) control unit. In this way, at least some control and/or monitoring of the ignition transformer may be performed locally at the ignition transformer.

The ignition coil assembly(ies) 104 may include functionality such as power supply (e.g., 2^{nd} stage), a capacitive discharge ignition driver, an ignition transformer, and engine diagnostic interfaces, although not limited thereto. One skilled in the art appreciates the various functions that may be incorporated into an ignition coil assembly 104 according to the present teachings.

Each ignition coil assembly 104 may communicate with the central control unit 102 through one or more communication links 106 (e.g., bus, cable, etc.). In one embodiment, the link/bus comprises a standardized twisted pair cable (e.g., category 5 or 6), although any wire/cable capable of satisfying the communication requirements between the central and distributed control units may be used, as is appreciated by one skilled in the art.

Having control electronics local to the ignition coil allows for a number of benefits. In this way, each coil can effectively operate independently or semi-independently and react to local conditions quickly for a particular application.

One benefit of the present teachings includes minimization of cabling between individual coils (e.g., cylinders) and a central control module. Since signals can be processed locally at the coil, for example, a smaller number of conductors is needed for coordination and serial communications with the central unit.

Another benefit is that control electronics within the coil allow for shorter and more controlled electrical paths in both the power and measurement circuits. This reduces effects from things like undesirable transfer of energy (e.g., loss W=(IR)I or “I2R loss”), stray capacitance, etc., although not limited thereto.

Still further, another benefit of the distributed architecture is that it can provide high primary drive voltages while maintaining low-voltage cabling. Typical capacitive discharge (CDI) ignition coil primary drive voltages may be in the range of 100-400VDC (pulsed) due to practical limitations in cabling insulation ratings, personnel safety, etc. However, higher primary drive voltages may be advantageous for lower current switching, smaller magnetic circuits, etc., as is appreciated by one skilled in the art. By distributing a lower voltage, for example by 48VAC in one example, and locally stepping it up to the final primary drive within the coil assembly, it is possible to have higher primary drive voltages while maintaining low-voltage cabling. Thus, the present teachings may provide for higher voltages than those found in known systems.

Voltages much greater than 400V have been impractical due to the limits of normal wiring practices (e.g., 480VAC 3-phase may be the highest voltage normally encountered by electricians). Using the present teachings, however, low voltage could be distributed and charge a capacitor to a much higher voltage, such as 600-900VDC, or even 1200-1800VDC, although not limited thereto. The benefit of distributing low voltage is that, regardless of the stepped-up primary voltage (e.g., 400VDC, 500VDC, 600VDC, 700VDC, 800VDC, 900VDC, 1000VDC, 1100VDC, 1200VDC, 1300VDC, 1400VDC, 1500VDC, 1600VDC, 1700VDC, 1800VDC, etc.), the low voltage being distributed (e.g., less than 100V, less than 75V, less than 50V, 48V, etc.) remains “touch safe”. As an example, 48V is touch safe whereas even 200VDC can be dangerous.

Stepping up voltages is known in the art, and can be provided in the ignition coil assembly by an AC-DC or DC-DC power supply, as an example. In another example, a supplemental transformer and/or diodes may be employed, although not limited thereto.

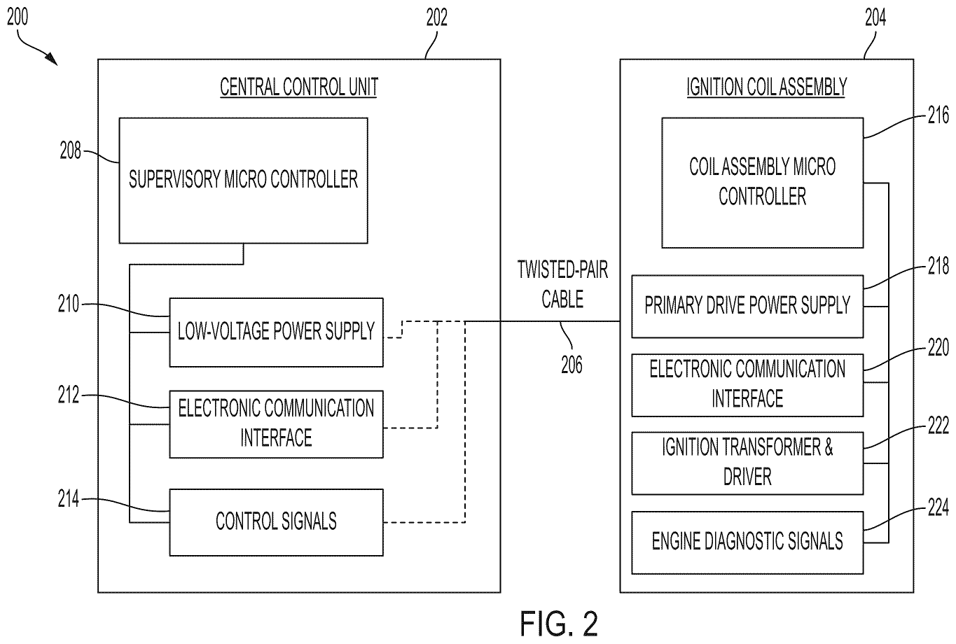

Referring to FIG. 2, shown is an illustration of another embodiment of a system 200 according to the present teachings. As shown, a central control unit 202 (e.g., ECU, CPU, etc.) is in electronic communication with at least one ignition coil assembly 204. In this example, communication is over a twisted-pair cable 206, although any cabling capable of satisfying the communication requirements may be used (e.g., wireless control and monitoring), as is appreciated by one skilled in the art.

While a single ignition coil assembly 204 is shown and may be referred to herein, many ignition coil assemblies 204 may be connected to the central control unit 202. The disclosed functionality applies when there are multiple ignition coil assemblies 204, as is appreciated by one skilled in the art (e.g., one or more for each engine cylinder).

The central control unit 202 may have a micro controller 208 (e.g., processor, memory, input/output, etc.). The micro controller 208 may control and monitor operation of the one or more ignition coil assemblies 204. In a preferred embodiment, the central control unit 202 may have supervisory monitoring and control capabilities since at least some functionality has been distributed to the ignition coil assemblies 204 in accordance with the present teachings.

One skilled in the art appreciates the different supervisory monitoring and control capabilities that may be incorporated into the present teachings. For example, the capabilities may include reading position data of the engine crank shaft and instructing the coil on an appropriate time to fire. In another example, the capabilities may include monitoring diagnostic data from a cylinder and adjusting one or more other cylinders in response, although not limited thereto. Diagnostic data may be used to monitor engine performance, such as engine stability or fluctuations in speed/torque. Diagnostic data may include data from the cylinders to be analyzed (e.g., left engine bank is higher voltage than right engine bank, etc.), although not limited thereto.

In one embodiment, the central control unit 202 may provide low voltage power supply 210 (e.g., touch safe voltage, 48V, etc.) to the ignition coil assembly 204. The central control unit 202 may have an electronic communication interface 212 for communicating with the ignition coil assembly 204 (e.g., receiving and sending communication signals, etc.). The central control unit 202 may provide control signals 214 for controlling and/or monitoring aspects of the ignition coil assembly 204. It is appreciated that the central control unit 202 may have various functionality, implemented in hardware and/or software, for interacting with the ignition coil assemblies 204, as is appreciated by one skilled in the art.

Each ignition coil assembly 204 may have a micro controller 216 (e.g., processor, memory, input/output, etc.). This way, at least some of the control operations may be performed “local” to the ignition coil assembly 204. This may include spark generation (e.g., a bitstream of pulses going to a switch), diagnostic measurements (e.g., primary and/or secondary current and voltage), etc., as is appreciated by one skilled in the art.

The ignition coil assembly 204 may have a primary drive power supply 218. The ignition coil assembly 204 may have an electronic communication interface 220 (e.g., for communicating with central control unit 202, other ignition coil assemblies, etc.). The ignition coil assembly 204 may have an ignition transformer 222 and driver (i.e., controllable switch/“output stage” of the ignition). The ignition coil assembly 204 may have engine diagnostics signals 224. It is appreciated that the ignition coil assembly 204 may have various functionality, implemented in hardware and/or software, for interacting with other parts of the system, such as the central control unit 202, as well as for controlling the ignition transformer 222 (e.g., regulating ignition timing, etc.), as is appreciated by one skilled in the art.

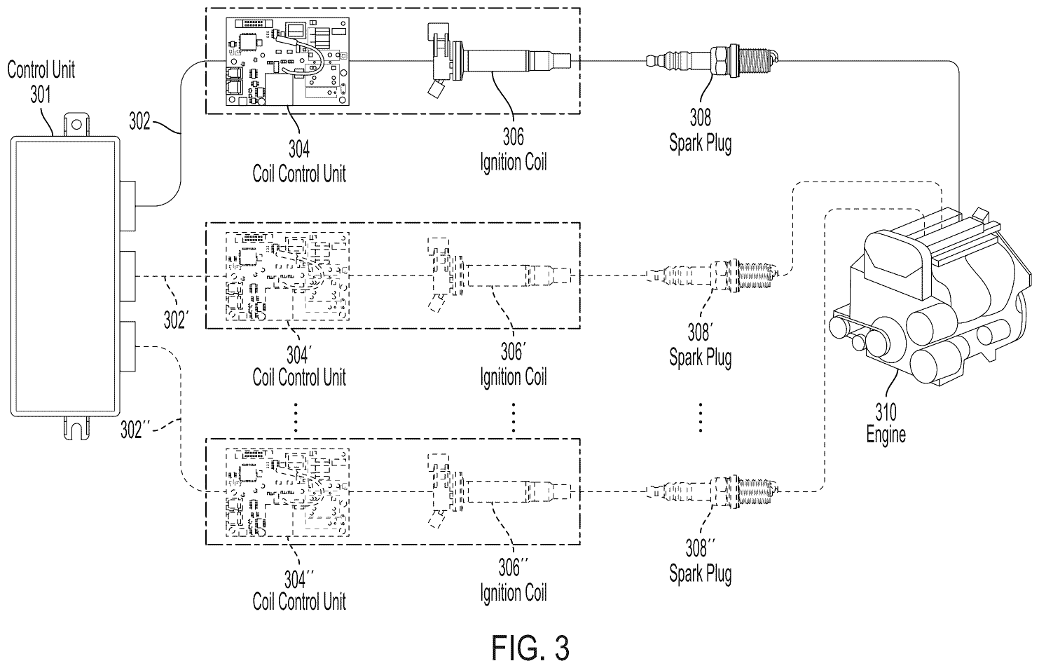

Referring to FIG. 3, shown is an illustration of the embodiments of FIGS. 1 and 2 incorporated into an engine ignition control. As shown, a control unit 301 (e.g., central) may be in electronic communication with one or more ignition control assemblies 304, 306. Each assembly may include a control unit 304 (e.g., local) and an ignition coil 306. Communication between the central control unit 301 and “local” control units 304, 304′, 304″ may be performed over one or more communication links 302, 302′, 302″. Each assembly may send energy to a spark plug 308, 308′, 308″. The spark plugs may in turn drive crankshafts in an engine 310 (e.g., one or more spark plugs in each engine cylinder), as is appreciated by one skilled it the art.

While the present teachings have been described above in terms of specific embodiments, it is to be understood that they are not limited to these disclosed embodiments. Many modifications and other embodiments will come to mind to those skilled in the art to which this pertains, and which are intended to be and are covered by this disclosure. It is intended that the scope of the present teachings should be determined by proper interpretation and construction of its legal equivalents, as understood by those of skill in the art relying upon the disclosure in this specification and the attached drawings.

What is claimed is:

1. An ignition system, comprising:
an ignition coil assembly having:
an ignition transformer with primary and secondary windings;
a local control unit adapted to regulate ignition timing of the ignition transformer for generating a spark at a spark apparatus to ignite a fuel-air mixture in an engine cylinder;
a central control unit in electronic communication with the local control unit for monitoring the ignition transformer.

2. The system of claim 1, wherein the ignition coil assembly steps up a final primary drive within the ignition coil assembly, such that a higher primary drive voltage is provided while using low-voltage cabling with the central control unit.

3. The system of claim 2, wherein the ignition coil assembly includes a power supply to step up the final primary drive.

4. The system of claim 2, wherein the central control unit provides 50V or less to the ignition coil assembly, which steps up the final primary drive to 400V or more.

5. The system of claim 1, wherein the central control unit is in electronic communication with the local control unit over a twisted pair cable.

6. The system of claim 5, wherein the twisted pair cable comprises Ethernet cable.

7. The system of claim 1, wherein the spark apparatus comprises a spark plug.

8. The system of claim 1, further comprising:
one or more additional ignition coil assemblies;
each of the one or more additional ignition coil assemblies having a local control unit adapted to regulate ignition timing of an associated ignition transformer.

9. An engine system, comprising:
an engine;
the ignition system of claim 8;
such that each ignition coil assembly regulates ignition timing of an associated ignition transformer for generating a spark at a spark apparatus to ignite a fuel-air mixture in a cylinder of the engine.

10. The system of claim 1, wherein:
the ignition coil assembly includes at least one measured value, such that the local control unit regulates ignition timing based on the at least one measured value;
the central control unit is in electronic communication with the local control unit over a twisted pair cable.

11. A method for controlling an ignition system, comprising:
providing an ignition coil assembly having:
an ignition transformer with primary and secondary windings;
a local control unit;
regulating ignition timing of the ignition transformer with the local control unit to generate a spark at a spark apparatus to ignite a fuel-air mixture in an engine cylinder;
monitoring the ignition transformer with a central control unit.

12. The method of claim 11, wherein:
the ignition coil assembly includes at least one measured value, such that the local control unit regulates ignition timing based on the at least one measured value;
the central control unit is in electronic communication with the local control unit over a twisted pair cable.

13. An ignition coil assembly, comprising:
an ignition transformer with primary and secondary windings;
a local control unit adapted to regulate ignition timing of the ignition transformer for generating a spark at a spark apparatus for igniting a fuel-air mixture in an engine cylinder;
the local control unit adapted to be in electronic communication with a central control unit that monitors the ignition transformer.

14. The assembly of claim 13, wherein:
the ignition coil assembly includes a power supply to step up the final primary drive in the ignition coil assembly, such that a higher primary drive voltage is provided while using low-voltage cabling with the central control unit.

15. The assembly of claim 13, wherein:
the ignition coil assembly includes at least one measured value, such that the local control unit regulates ignition timing based on the at least one measured value.

16. The assembly of claim 15, wherein:
the ignition coil assembly includes at least one sensor for sensing the at least one measured value.

17. The assembly of claim 15, wherein the at least one measured value comprises position data of an engine crank shaft.

18. An engine ignition system, comprising:
an engine having a plurality of cylinders;
each of the plurality of cylinders having an associated assembly of claim 13;
a central control unit in electronic communication with each associated assembly over a twisted pair cable.

19. The system of claim 18, wherein the central control unit receives a diagnostic measurement of a first of the associated assemblies and modifies operation of at least a second of the associated assemblies based at least in part on the diagnostic measurement.

20. The system of claim 18, wherein:
a local control unit increases voltage of a primary drive within one of the associated assemblies;
the central control unit is in electronic communication with the local control unit over a twisted pair cable.
